(19) United States
(12) Patent Application Publication
(10) Pub. No.: US 2006/0044288 A1
(43) Pub. Date: Mar. 2, 2006

(54) Multi-functional electronic device utilizing a stylus pen

(76) Inventors: Hiroshi Nakamura, Tokyo (JP); Toshiyuki Tanaka, Laguna Niguel, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/871,080

(22) Filed: Jun. 18, 2004

(51) Int. Cl. G09G 5/00

(52) U.S. Cl. 345/179

(57) ABSTRACT

According to one embodiment of the invention, an electronic device, such as a tablet PC for example, is designed with a housing and a cover configured for attachment to the housing. The housing includes a front panel and a back panel having a base unit with a recess to receive a stylus pen to operate as a leg to maintain the housing in an upright position. Alternatively, the housing may include a control button to receive a stylus pen so that the combination operates as an input device similar to a joystick.

### FIELD

Embodiments of the invention relate to the field of electronics. More specifically, one embodiment of the invention relates to a multi-functional electronic device that can be utilized as a portable computer, a desktop computer and a flat panel television.

### GENERAL BACKGROUND

Over the past few years, there has been an increased demand for portable computers, especially in light of their enhanced data processing functionality. One type of portable computer is referred to as a tablet personal computer (hereinafter referred to as a “tablet PC”). Sized slightly larger than a personal digital assistant (PDA), a tablet PC features a touch panel display used in combination with a stylus pen.

During operation, the tablet PC may be held as a writing pad with the stylus pen used, for example, to select objects (e.g., icons, drop-down menus, etc.) displayed on the touch panel display. Upon selection of the displayed objects, various operations are performed. For instance, the tablet PC may execute handwriting recognition software that enables the user to highlight, save, sort, alter and search for handwritten notes.

Previous embodiments of the tablet PC have been implemented with a finger touch pad having a centrally recessed area as set forth in Japanese Patent Application JP-A-H9-19042. This type of finger touch pad is not adapted to receive the stylus pen. In fact, the current design fails to provide its user with sufficient dynamic and refined control of the tablet PC. The lack of such refined control has caused user frustration in use of the tablet PC.

In addition, when a user purchases a tablet PC, he or she normally purchases a briefcase to store and protect the tablet PC from being damaged during transit. The briefcase includes pockets to store items such as the stylus pen. However, this briefcase does not provide any additional functionality.

### BRIEF DESCRIPTION OF THE DRAWINGS

Features and advantages of embodiments of the invention will become apparent from the following detailed description in which

FIG. 1 is a perspective view of an exemplary embodiment of an electronic device, such as a tablet PC for example, placed in an unused state.

FIG. 2 is a perspective view of an exemplary embodiment of the tablet PC being converted from its unused state into another state.

FIG. 3 is a perspective view of an exemplary embodiment of the tablet PC placed in a first operational state is shown.

FIG. 4 is a first perspective view of an exemplary embodiment of the tablet PC placed in a second operational state.

FIG. 5 is a second perspective view of the tablet PC placed in the second operational state.

FIG. 6 is a cut-away view of an exemplary embodiment of the cursor button of FIG. 5.

FIG. 7 is a cross-sectional view of the cursor button of FIG. 6 along line 7-7.

FIG. 8 is a first exemplary embodiment of the electronic device being placed in a landscape orientation to operate as a part of the desktop computer or a flat panel television.

FIG. 9 is a second exemplary embodiment of the electronic device being placed in a portrait orientation to operate as a part of the desktop computer or a flat panel television.

### DETAILED DESCRIPTION

Embodiments of the invention set forth in the following description generally relate to a portable electronic device normally used as a portable computer, but may be also used as part of a desktop computer or a flat panel television. These additional embodiments utilize a housing cover having a rotational base unit as described below. The rotational base unit in cooperation with a stylus pen operates as a stand for the electronic device.

In the following description, certain terminology is used to describe various features of one or more embodiments of the invention. For instance, an “electronic device” is generally defined as a portable product having a flat panel display including, but not limited or restricted to a portable computer, a wireless cellular telephone, or a personal digital assistant. In this detailed description, for clarity's sake, the electronic device is illustrated as a specific type of portable computer, namely a tablet PC. It is contemplated, however, that the invention may be implemented for use by any other type of electronic device.

As described below, the tablet PC can be used in a variety of capacities, prompting deployment in a variety of operational states. For instance, according to one embodiment of the invention, the electronic device is used as a tablet PC that operates in response to selection of displayed objects by a stylus pen. The tablet PC is normally held by the user or placed display-up on a solid surface during operation. In an alternative embodiment of the invention, this tablet PC may be used as part of a desktop computer. For this embodiment, the tablet PC receives input data from one or more wired or wireless peripheral input sources (e.g., wired or wireless keyboard, wired or wireless mouse, etc.). In yet another alternative embodiment of the invention, the tablet PC may be used as a television, and thus, receives input data from a remote control.

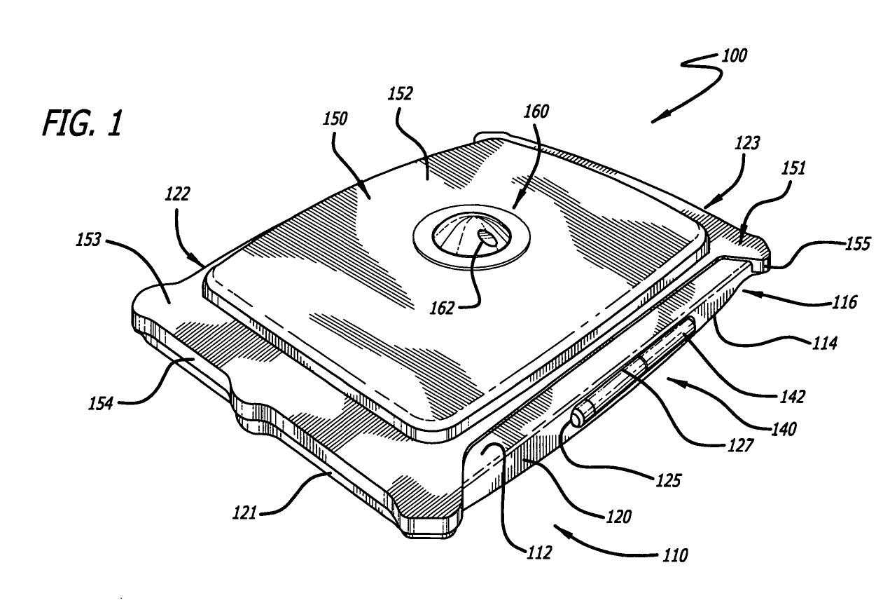

Referring now to FIG. 1, a perspective view of an exemplary embodiment of an electronic device 100 (e.g., tablet PC) placed in an unused state is shown. Tablet PC 100 comprises a housing 110, a flat panel display 130 such as a touch panel display (not shown), and a housing cover 150. For instance, housing cover 150 is formed to cover a substantial portion of a front panel 112 of housing 110, including the touch panel display. Tablet PC 100 is normally placed in the unused state during transport or storage.

As shown, housing 110 houses various interconnected hardware components (e.g., processor, chipset, memory, optional television receiver, etc.) and stored software in order to protect these components from damage and environmental contaminants. Housing 110 comprises front panel 112, a back panel 114, and a plurality of side panels 116. These panels are made of a non-pliable material (e.g., synthetic resin, magnesium alloy, etc.). Panels 112 and 114 are connected together by side panels 116, such as side panels 120-123 for example, so that housing 110 is an enclosed housing as shown.

One of the side panels 120 is formed with a slot 125 sized to house a stylus pen 140 when not in use. Stylus pen 140 is maintained in slot 125 by configuring an edge 127 of slot 125 with a downward curved flange slightly extending over the opening of slot 125. This overextending edge 127 prevents stylus pen 140 from being accidentally dislodged during transport.

Housing cover 150 is sized to cover a substantial portion of a surface of front panel 112 of housing 110. According to this embodiment of the invention, housing cover 150 comprises a multi-tier top surface 151 having a first-tier surface 152 raised above a second-tier surface 153. Second-tier surface 153 comprises a plurality of flanges (e.g., flanges 154 and 155), which are formed along selected edges of second-tier surface 153 in order to partially cover at least two side panels as well as the corners of housing 110 partially formed by adjoining side panels 120-123. According to this embodiment of the invention, side panels 121 and 123 are partially covered by flanges 154 and 155 while side panels 120 and 122 are fully exposed. It is contemplated, however, that housing cover 150 may be formed in another embodiment to partially or fully cover any of side panels 120-123.

Housing cover 150 is attached to housing 110 by a fastening element (not shown). According to one embodiment of the invention, the fastening element may include one or more fasteners positioned along an edge of second-tier surface 153 for coupling to and decoupling from a complimentary fastener placed on a corresponding side panel 120, . . . , or 123 of housing 110. Alternatively, according to another embodiment of the invention, the fastening element may be accomplished by sizing housing cover 150 so that flanges 154 and 155 securely engage with portions of side panels 120-123. For instance, complementary protrusions of a selected length may be placed along the inner surface of flanges 154 and 155 and side panels 121 and 123. These protrusions are engaged when the housing cover 150 is placed over front panel 112. Cover 150 becomes disengaged from housing 110 by applying outward pressure to the edges of second-tier surface 153 having flanges 154 and 155, followed by upper movement of cover 150.

As shown, a base unit 160 is positioned on raised first-tier surface 152. According to one embodiment of the invention, base unit 160 is positioned general proximate to a center of housing cover 150. It is contemplated, however, that by offsetting the position of base unit 160 from the center of housing cover 150, housing 110 may achieve a viewing angle closer to ninety (90°) degrees when cover 150 is fitted onto its back panel 114 and tablet PC 100 is used as a desktop computer or television as described below. The “viewing angle” is defined as the angle between the top surface of front panel 112 and the surface on which housing 110 is maintained.

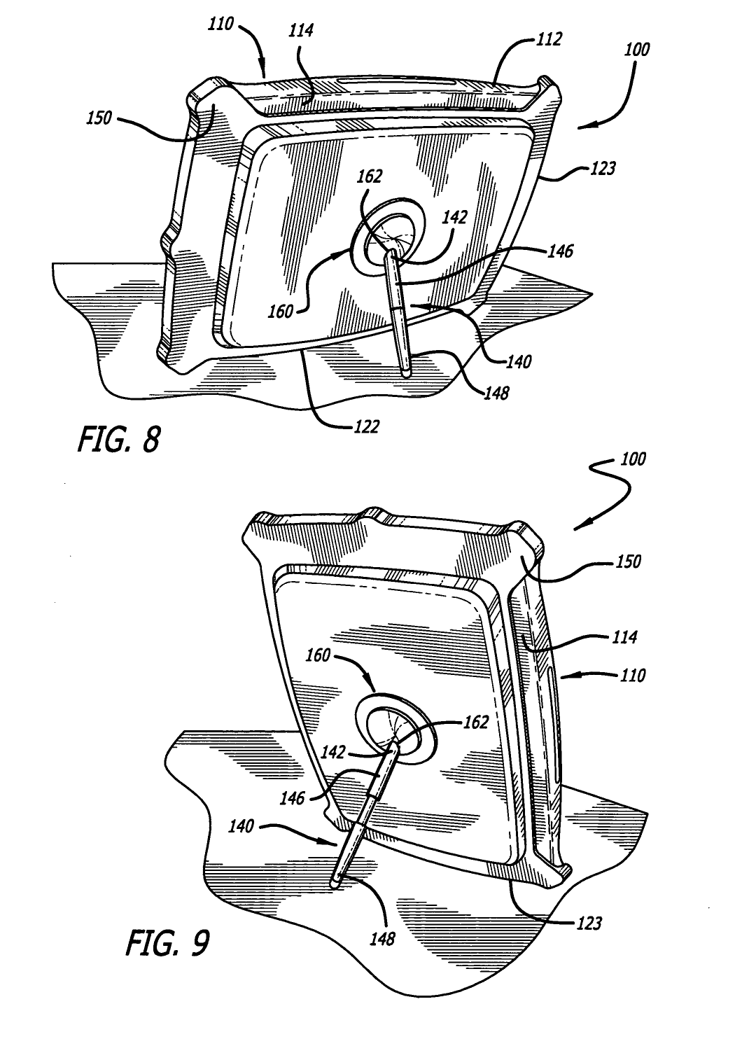

Base unit 160 may be adapted according to a number of embodiments. For example, according to one embodiment of the invention, base unit 160 may be rotated in a clockwise and counter-clockwise direction within a range of approximately ninety degree (90°). This enables tablet PC 100 to be placed in a landscape or portrait orientation after housing cover 150 is placed on back panel 114 of housing 110 as shown in FIGS. 8-9.

As further shown in FIG. 1, base unit 160 comprises an angled recess 162 sized with a sufficient diameter to receive a first end 142 of stylus pen 140. Hence, when base unit 160 is configured to rotate as described above, recess 162 generally faces one of side panels (e.g., side panel 122) when base unit 160 is situated for placement in a landscape orientation and faces a different side panel (e.g., side panel 123) when base unit 160 is situated for placement in a portrait orientation.

In addition, recess 162 may further include an optional secondary recess (not shown) sized to receive a protrusion 144 extending from first end 142 of stylus pen 140. The secondary recess provides an additional mechanism to retain stylus pen 140 within recess 162 when inserted therein.

According to one embodiment of the invention, recess 162 is angled to create a selected angle of intersection between stylus pen 140 (when inserted) and first-tier surface 152. According to one embodiment of the invention, the angle of intersection approximately ranges between twenty and sixty degrees (20°-60°) although other angles of intersection may be utilized.

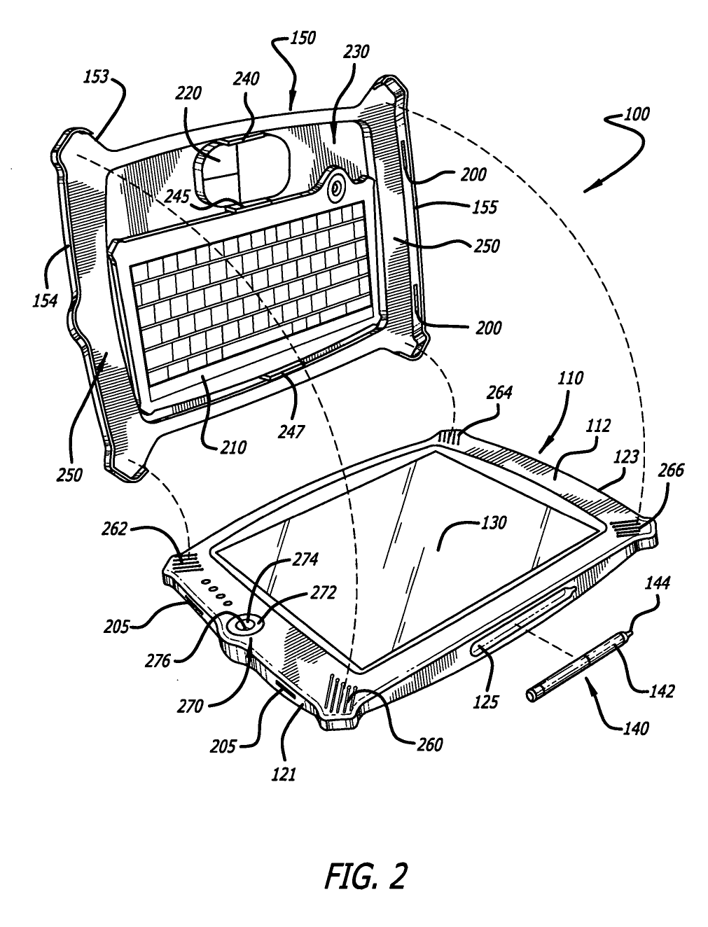

Referring now to FIG. 2, a perspective view of an exemplary embodiment tablet PC 100 being converted from its unused state into another state is shown. For example, cover 150 is removed from housing 110 by disengaging flanges 154 and 155 of second-tier surface 153 from side panels 121 and 123 of housing 110. For instance, as an example, one or more complementary protrusions 200 and 205 of a selected length may be placed along the inner surface of flanges 154 and 155 and side panels 121 and 123. These protrusions 200 and 205 are engaged when the housing cover 150 is firmly placed over front panel 112 (e.g., protrusion(s) 200 forced below protrusion(s) 205). Cover 150 becomes disengaged from housing 110 by applying outward pressure to the edges of second-tier surface 153 having flanges 154 and 155 so that protrusion(s) 200 clear protrusion(s) 205, followed by upper movement of cover 150.

As further shown, a wireless keyboard 210 and wireless mouse 220 are positioned within a recessed area 230 formed by raised first-tier surface 152. Fastening elements 240, 245 and 247 are positioned to maintain keyboard 210 and mouse 220 within recessed area 230 until removed by the user.

An interior 250 of second-tier surface 153 is contoured to securely fit over front panel 112 of housing 110. As shown, according to one embodiment of the invention, interior 250 is gradually sloped from flanges 154 and 155 toward recessed area 230. This provides additional clearance of keyboard 210 and mouse 220 over touch panel display 130 when positioned within recessed area 230.

As further shown in FIG. 2, front panel 112 comprises an opening for a screen of touch panel display 130 so as to surround the screen. Speakers are placed at the corners of housing 110 and are positioned below openings 260, 262, 264, 266, which are formed within front panel 112 in order to allow audio produced by the speakers to freely propagate therefrom. These openings 260, 262, 264, 266 are visible when tablet PC 100 is placed in an operational state, but are covered by housing cover 150 when placed in the unused state.

In addition, a control button 270 is situated at front panel 112 in close proximity to sidewall 121. Control button 270 includes a circularly rotational outer ring 272 surrounding a recessed area 274. Recessed area 274 is sized with a diameter to receive stylus pen 140 and features an inner recess 276 (e.g., indentation) to receive a protrusion 144 extending from first end 142 of stylus pen 140. As a result, the opening for inner recess 276 is substantially smaller than the opening for recessed area 274.

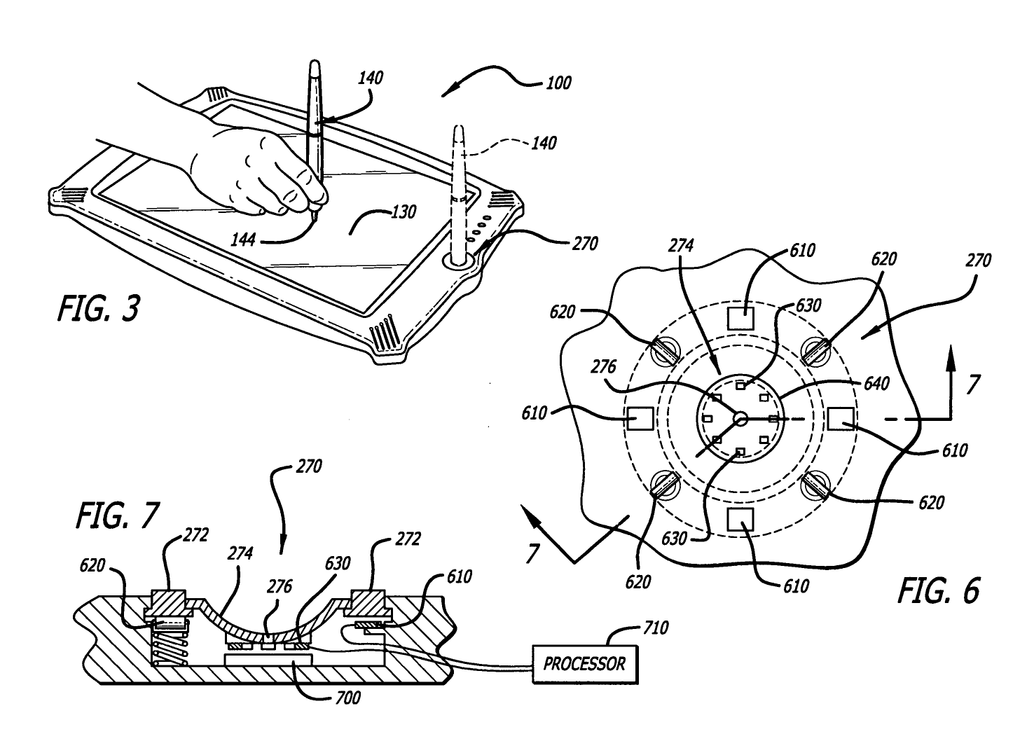

Referring now to FIG. 3, a perspective view of an exemplary embodiment of tablet PC 100 placed in a first operational state is shown. During use, tablet PC 100 is supported by the user. Stylus pen 140 is pressed against touch panel display 130 to control the operations of tablet PC 100 by selecting displayed icons and well as guided along touch panel display 130 to generate notes in “digital ink” within a writing area.

In addition, stylus pen 140 may be inserted into control button 270. In particular, protrusion 144 of stylus pen 140 is inserted into inner recess 276 and stylus pen 140 is adjusted as a joystick to control cursor positioning, display page scrolling, movement of a graphical object in a game or simulation program, and the like.

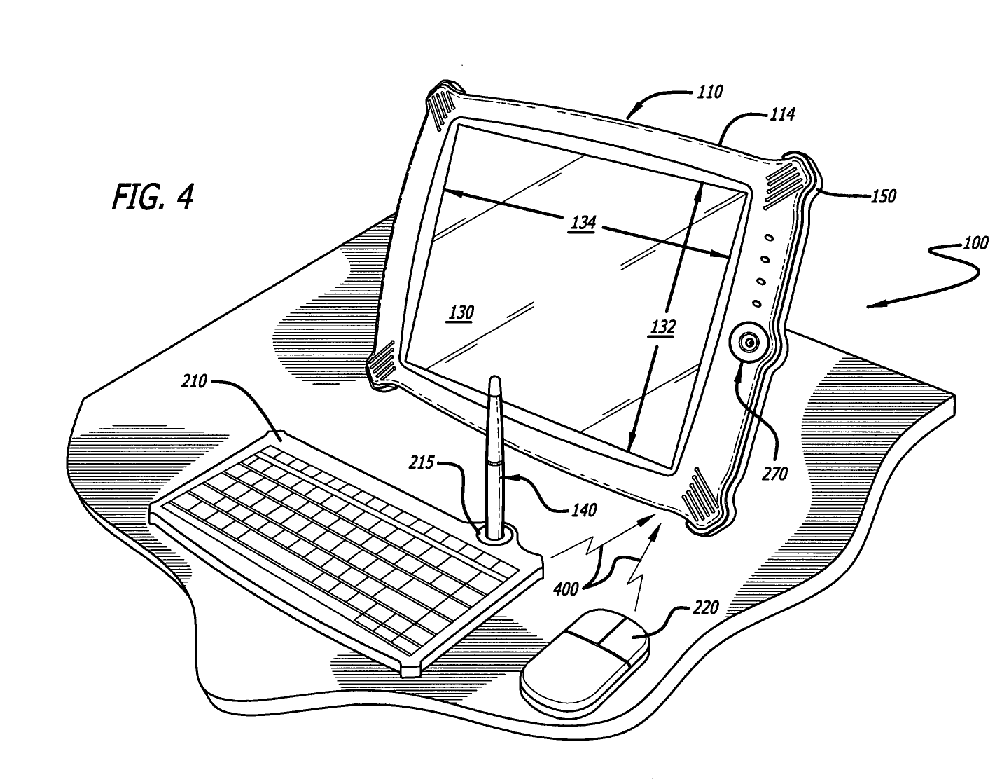

Referring to FIG. 4, a first perspective view of an exemplary embodiment of tablet PC 100 placed in a second operational state is shown. Herein, tablet PC 100 operates as a desktop computer by receiving wireless signals 400 from peripheral input source such as wireless keyboard 210 and wireless mouse 220 for example.

As shown in this embodiment of the invention, tablet PC 100 is positioned in a landscape orientation in which the height 132 of touch panel display 130 is less than the width 134 of display 130. This is accomplished by placing cover 150 behind back panel 114 of housing 110. Cover 150 supports tablet PC 100 in a generally upright position as illustrated in more detail in FIG. 8.

As further shown in FIG. 4, stylus pen 140 is inserted into a control button 215 of wireless keyboard 210. The architecture of control button 215 is identical to control button 270 positioned on housing 110 of tablet PC 100. However, control button 215 is in communication with a wireless transmitter (not shown) located within keyboard 210 instead of hardware components within tablet PC 100. Hence, when stylus pen 140 is tilted, keyboard 210 transmits wireless control signals 400 (e.g., radio frequency “RF” signals) to tablet PC 100. These wireless control signals may involve control of cursor movement or game operations with joystick functionality. When stylus pen 140 remains undisturbed, however, control button 215 merely acts as a storage location for stylus pen 140.

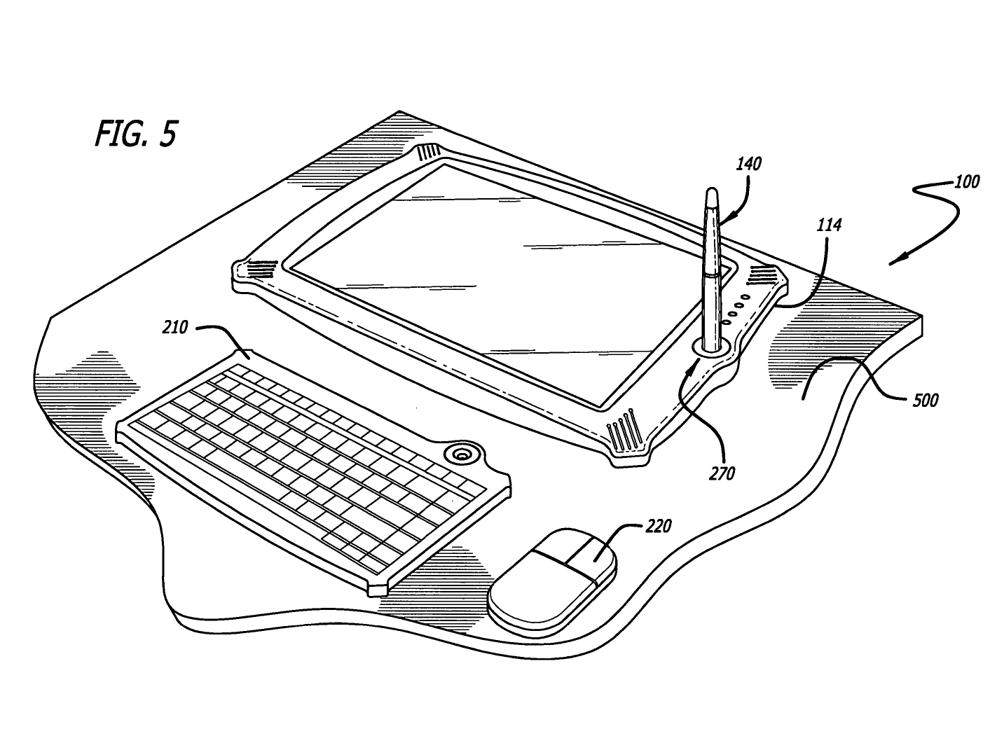

Referring now to FIG. 5, second perspective view of an exemplary embodiment of electronic device 100 placed in the second operational state is shown. Herein, tablet PC 100 is positioned with back panel 114 of housing 110 substantially flush against a surface 500 (e.g., desk top) also supporting keyboard 210 and mouse 220. Stylus pen 140 is inserted into the pivotal recess of control button 270 and is adjusted to control the operations of tablet PC 100. In addition, tablet PC 100 may receive signaling from keyboard 210 and mouse 220 over a wired or wireless interconnect.

Referring now to FIG. 6, a cut-away view of an exemplary embodiment of cursor button 270 of FIG. 5 is shown. For clarity sake, control button 270 has been described in lieu of control button 215. Of course, it is contemplated that the mechanical structure of control button 270 as described may be identical to control button 215 positioned within keyboard 210.

Control button 270 comprises rotational outer ring 272 under which a plurality of sensors 610 and a plurality of elements 620 (e.g., components to enable rotation and pivoting of outer ring 272 such as spring-loaded roller bearings) are positioned. For this embodiment of the invention, sensors 610 are positioned in a predetermined arrangement such as an arrangement where each sensor is positioned approximately ninety degrees (90°) from each other. It is contemplated, however, that sensors 610 may be positioned in any orientation and may exceed more than four in number. Roller bearings 620 are positioned in a circular orientation as well and interspersed between some or all of sensors 610.

A second plurality of sensors 630 is positioned under concave, recessed area 274 in order to detect pivoting of recessed area 274 upon adjustment (tilting) of the stylus pen when inserted. Second plurality of sensors 630 are positioned in a predetermined orientation, such as a circular orientation for example, between an outer edge 640 of recessed area 274 and inner recess 276.

Referring now to FIG. 7, a cross-sectional view along line 7-7 of control button 270 is shown. Roller bearing 620 is spring-loaded and enables both pivoting and rotation of outer ring 272 of control button 270 as well as pivoting of inner recess 274. Sensor 610 is in close proximity to outer ring 272 and detects rotation of outer ring 272 by electrical or mechanical means. Recessed area 274 features sensors 630 in close proximity to touch plate 700. Pivoting of recessed area 274 is detected when one of sensors 630 comes into contact with touch plate 700. This temporary coupling will cause movement of the cursor, or graphical object in a direction associated with sensor 630. These sensors 610 and 630 are directly or indirectly coupled to a processor 710 (e.g., a microprocessor, digital signal processor, microcontroller, application specific integrated circuit “ASIC”, etc.), which detects movement of the stylus pen and, in response, causes an event to occur (e.g., movement of cursor or graphical object, page scrolling, etc.).

Referring now to FIG. 8, an exemplary embodiment of tablet PC 100 placed in a third operational state is shown. Herein, tablet PC 100 is utilized as a flat panel television. The combination of the base unit 160 and stylus pen 140 maintains the tablet PC 100 (and display) in a substantially upright position. Of course, tablet PC 100 is placed in this configuration as well when deployed as a desktop computer illustrated in FIG. 4.

Housing cover 150 is positioned over back panel 114 of housing 110 and attached thereto. First end 142 of stylus pen 140 is inserted to angled recess 162 of base unit 160. More specifically, the protrusion at the first end of stylus pen 140 is inserted into the secondary recess within recess 162. According to one embodiment of the invention, stylus pen 140 is slidably expanded in order to alter the viewing angle between the top surface of front panel 112 and the surface on which side panel 122 is resting. This sliding movement may be controlled using springs or detents for example. According to another embodiment of the invention, stylus pen 140 may be expanded through rotation of either a top portion 146 or a bottom portion 148.

This expansion of the length of stylus pen 140 can be used to adjust the viewing angle, especially toward achieving a viewing angle of approximately ninety degrees (90°) to emulate a flat panel television. FIG. 9 illustrates tablet PC 100 positioned in a portrait orientation with stylus pen 140 expanded and housing 110 is resting on side panel 123.

In the foregoing description, the invention is described with reference to specific exemplary embodiments thereof. It will, however, be evident that various modifications and changes may be made thereto without departing from the broader spirit and scope of the present invention as set forth in the appended claims. For example, the base unit may be static (non-rotational), and instead, feature multiple recessed areas. These recessed areas are situated the base unit in order to maintain tablet PC in a portrait or landscape orientation. Therefore, the specification and drawings are accordingly to be regarded in an illustrative rather than in a restrictive sense.

What is claimed is:

1. An electronic device comprising:
a housing including a front panel, a back panel and a plurality of side panels each coupled to the front panel and the back panel, the front panel surrounding a screen of a display housed by the housing; and
a cover configured for attachment to the housing and for covering of a substantial portion of the back panel, the cover, in cooperation with a pen, maintaining the housing in an upright position.

2. The electronic device according to claim 1, wherein the housing is in the upright position when a first side panel of the plurality of side panels is raised and maintained above a second side panel of the plurality of side panels being positioned on an opposite side of the screen from the first side panel.

3. The electronic device according to claim 2, wherein a viewing angle, being an angle between a top surface of the front panel and a surface on which the housing is supported, is less than 135 degrees.

4. The electronic device according to claim 1, wherein the cover comprises a base unit including an angled recess sized to receive a first end of the stylus pen, the base unit being rotational to (i) support the housing in a first orientation with a first side panel of the plurality of side panels raised and maintained above a second side panel of the plurality of side panels with the second side panel being positioned on an opposite side of the screen from the first side panel and (ii) support the housing in a second orientation with a third side panel of the plurality of side panels, coupled to the first side panel and the second side panel, being raised and maintained above a fourth side panel of the plurality of side panels positioned on an opposite side of the screen from the third side panel.

5. The electronic device according to claim 4, wherein the angled recess includes a secondary recess to receive a protrusion on the first end of the pen.

6. The electronic device according to claim 1, wherein a length of the pen is adjustable.

7. The electronic device according to claim 1, wherein the housing further comprises a control button positioned on the front panel of the housing and adapted to control functionality of the electronic device, the control button includes (i) a pivotal recessed area sized to receive a first end of the pen, (ii) a first plurality of sensors positioned under the recessed area, (iii) a rotational outer ring surrounding the pivotal recessed area, and (iv) a second plurality of sensors positioned under the outer ring.

8. The electronic device according to claim 7, wherein the control button further comprises a plurality of elements to enable the recessed area to pivot and to enable the outer ring to pivot and rotate in a circular direction.

9. The electronic device according to claim 8, wherein the plurality of elements are spring-loaded roller bearings.

10. The electronic device according to claim 1, wherein the cover is further configured to attach to the housing while covering a substantial portion of the front panel including the screen.

11. The electronic device according to claim 10, wherein the cover comprises a multi-tier top surface with a raised first-tier surface and a recessed area under the raised first-tier surface being used for storage of at least one peripheral input source.

12. An electronic device comprising:
a touch panel display;
a housing to house the touch panel display, the housing including a front panel, a back panel and a plurality of side panels each coupled to the front panel and the back panel; and
a control button positioned on the front panel of the housing and adapted to (i) receive a stylus pen and to control functionality of the electronic device based on movement of the stylus pen and (ii) control functionality of the electronic device without attachment of the stylus pen.

13. The electronic device according to claim 12, wherein the control button comprises (i) a recessed area sized to receive a first end of a stylus pen, (ii) an outer ring surrounding the recessed area, and (iii) at least one sensor positioned under the control button to detect pivotal movement of the stylus pen and to detect movement of the outer ring.

14. The electronic device according to claim 13, wherein the at least one sensor comprises a first plurality of sensors positioned under the recessed area, and a second plurality of sensors positioned under the outer ring.

15. The electronic device according to claim 14, wherein the second plurality of sensors to detect circular rotation of the outer ring.

16. The electronic device according to claim 14, wherein the second plurality of sensors to detect pivotal movement rotation of the outer ring.

17. The electronic device according to claim 13, wherein the control button further comprises a plurality of elements to enable the recessed area to pivot and to enable the outer ring to rotate in a circular direction around the recessed area.

18. The electronic device according to claim 14, wherein the control button further comprises a plurality of elements to enable the recessed area to pivot and to enable the outer ring to rotate in a circular direction around the recessed area and the pivoting of the recessed area is detected by at least one of the first plurality of sensors that, in response, generates a control signal to a processor processing data within the electronic device, the control signal signaling the processor to cause an event to occur.

19. The electronic device according to claim 18, wherein the circular rotation of the outer ring is detected by at least one of the second plurality of sensors that, in response, generates a control signal to a processor processing data within the electronic device, the control signal signaling the processor to cause an event to occur.

20. The electronic device according to claim 19, wherein the event includes movement of the cursor.

21. An electronic device comprising:
a display;
a stylus pen having a first end and a second end;
a housing to house the display, the housing including a front panel and a back panel including a base unit having at least one recess sized to receive the first end of the stylus pen; and
a cover adapted to substantially cover the front panel including the display when the electronic device is placed in a first state and to substantially cover the back panel when the electronic device is placed in a second state, the stylus pen being inserted into the recess of the base unit to place the display in an upright position when the electronic device is placed in the second state.
